(19) United States
(12) Patent Application Publication
(10) Pub. No.: US 2026/0177512 A1
(43) Pub. Date: Jun. 25, 2026

(54) SCANNING CONTROL APPARATUS AND SEMICONDUCTOR INSPECTION DEVICE

(71) Applicant: DONGFANG JINGYUAN ELECTRON CO., LTD., Beijing (CN)

(72) Inventors: Shuang Gao, Beijing (CN); Xiwen Jia, Beijing (CN)

(21) Appl. No.: 19/539,868

(22) Filed: Feb. 13, 2026

(30) Foreign Application Priority Data
Mar. 10, 2025 (CN) 202510276306.8

(51) Int. Cl. G01N 23/2251

(52) U.S. Cl. CPC G01N 23/2251; G01N 2223/306; G01N 2223/33; G01N 2223/6116

(57) ABSTRACT

Provided are a scanning control apparatus and a semiconductor inspection device. The scanning control apparatus can include a first chip, a control chip, and a storage chip. The control chip is connected to the first chip and the storage chip. The first chip is configured to generate a scanning waveform parameter based on a scanning parameter. The storage chip is configured to receive the scanning waveform parameter transmitted from the first chip through the control chip and store the scanning waveform parameter. The control chip is configured to receive a first signal transmitted from the storage chip after the scanning waveform parameter is stored, acquire the scanning waveform parameter from the storage chip according to the first signal, and output the scanning waveform parameter. The scanning waveform parameter is configured to instruct the generation of the scanning waveform.

### CROSS-REFERENCE TO RELATED APPLICATIONS

This application claims priority to Chinese Patent Application No. 202510276306.8, filed on March 10, 2025, which is hereby incorporated by reference in its entirety.

### TECHNICAL FIELD

The present disclosure relates to the technical field of semiconductor inspection, and in particular to a scanning control apparatus and a semiconductor inspection device.

### BACKGROUND

A charged particle beam inspection and imaging device such as a scanning electron microscope (SEM) has been widely used in the field of semiconductor inspection. The SEM is a high-resolution electron-based optical instrument and has been widely used in the field of semiconductor inspection. The SEM can generate a scanning parameter through a field programmable gate array (FPGA), and a charged particle beam emission module can emit a charged particle beam based on the scanning parameter. However, the above method has the problem that the generation speed of the scanning parameter is slow, which reduces the semiconductor inspection efficiency.

### SUMMARY

Some embodiments of the present disclosure provide a scanning control apparatus, a method, an apparatus, a medium, a product, and a semiconductor inspection device, which can improve the generation efficiency of the scanning waveform parameter, thereby reducing the time for a scanning electron microscope to scan a frame of image, and improving the semiconductor inspection efficiency.

In a first aspect, some embodiments of the present disclosure provide a scanning control apparatus. The scanning control apparatus includes a first chip, a control chip, and a storage chip. The control chip is connected to the first chip and the storage chip. The first chip is configured to generate a scanning waveform parameter based on a scanning parameter. The storage chip is configured to receive the scanning waveform parameter transmitted from the first chip through the control chip, and store the scanning waveform parameter. The control chip is configured to receive a first signal transmitted from the storage chip after the storage chip stores the scanning waveform parameter, acquire the scanning waveform parameter from the storage chip according to the first signal, and output the scanning waveform parameter, the scanning waveform parameter being configured to instruct a generation of a scanning waveform.

In a second aspect, some embodiments of the present disclosure provide a semiconductor inspection device. The semiconductor inspection device includes a charged particle beam emission module and the scanning control apparatuses described in the first aspect. The scanning control apparatus is configured to transmit the scanning waveform parameter to the charged particle beam emission module, and the charged particle beam emission module is configured to generate a scanning waveform of a charged particle beam in response to the scanning waveform parameter.

In a third aspect, some embodiments of the present disclosure provide a scanning control method applied to a scanning control apparatus. The scanning control apparatus includes a control chip, a first chip, and a storage chip, and the control chip is connected to the first chip and the storage chip. The method includes: generating, by the first chip, a scanning waveform parameter based on a scanning parameter; receiving, by the storage chip, the scanning waveform parameter transmitted from the control chip, and storing the scanning waveform parameter that is a parameter transmitted from the first chip to the control chip; receiving, by the control chip, the first signal transmitted from the storage chip after the storage chip stores the scanning waveform parameter, acquiring the scanning waveform parameter from the storage chip according to the first signal, and outputting the scanning waveform parameter. The scanning waveform parameter is configured to instruct a generation of a scanning waveform.

In a fourth aspect, some embodiments of the present disclosure provide an electronic device. The electronic device includes a processor and a storage storing computer program instructions. The computer program instructions, when executed by the processor, cause the processor to perform the scanning control method described in the third aspect.

In a fifth aspect, some embodiments of the present disclosure provide a computer readable storage medium storing computer program instructions. The computer program instructions, when executed by the processor, cause the processor to perform the scanning control method described in the third aspect.

In a sixth aspect, some embodiments of the present disclosure provide a computer program product including a computer program. The computer program, when executed by a processor, cause the processor to perform the scanning control method according to the third aspect.

### BRIEF DESCRIPTION OF THE DRAWINGS

In order to illustrate technical solutions of embodiments of the present disclosure more clearly, the drawings required for the embodiments of the present disclosure will be briefly described. For a person skilled in the art, other drawings can also be obtained from these drawings without creative effort.

FIG. 1 is a schematic diagram of a scanning control apparatus provided in some embodiments of the present disclosure.

FIG. 2 is another schematic diagram of a scanning control apparatus provided in some embodiments of the present disclosure.

FIG. 3 is another schematic diagram of a scanning control apparatus provided in some embodiments of the present disclosure.

FIG. 4 is a flow chart of a scanning control method provided in some embodiments of the present disclosure.

FIG. 5 is a schematic diagram of a semiconductor inspection device provided in some embodiments of the present disclosure.

FIG. 6 is a hardware schematic diagram of an electronic device provided in some embodiments of the present disclosure.

### DETAILED DESCRIPTION

Features of various aspects and exemplary embodiments of the present disclosure will be described in detail below. In order to make objects, technical solutions and advantages of the present disclosure clearer, the present disclosure is further described in detail below with reference to the drawings and specific embodiments. It should be understood that the specific embodiments described herein are merely intended to explain the present disclosure, rather than to limit the present disclosure. For those skilled in the art, the present disclosure can be implemented without some of these specific details. The following description of the embodiments is only to provide a better understanding of the present disclosure by illustrating examples of the present disclosure.

It should be noted that, in the present disclosure, the relational terms, such as first and second, are used merely to distinguish one entity or operation from another entity or operation, without necessarily requiring or implying any actual such relationships or orders for these entities or operations. Moreover, the terms “comprise”, “include”, or any other variants thereof, are intended to represent a non-exclusive inclusion, such that a process, method, article or device including a series of elements includes not only those elements, but also other elements that are not explicitly listed or elements inherent to such a process, method, article or device. Without more constraints, the elements following an expression “comprise/include…” do not exclude the existence of additional identical elements in the process, method, article or device that includes the elements.

Before describing the technical solutions according to the embodiments of the present disclosure, the present disclosure first specifically describes the problems in the related art to facilitate understanding of the embodiments of the present disclosure.

At present, in the field of semiconductor inspection, a charged particle beam inspection device such as a SEM has been widely used to scan a semiconductor to obtain a scanning image and inspect semiconductor defects through the scanning image. The SEM in the related art mainly uses a scanning waveform parameter generated by a soft core in a FPGA, and multiple target voltage values in the scanning waveform parameter can control a voltage value of a coil in a charged particle beam emission module so that the charged particle beam emission module emits a charged particle beam. However, the soft core has a relatively low computational power, leading to a low the generation speed of the scanning waveform parameter. For example, it may require 450 ms to generate the scanning waveform parameter for an image size of 512 × 512, which does not satisfy existing production requirements, reducing the subsequent semiconductor inspection efficiency.

Meanwhile, in the related art, the scanning waveform parameter is often stored in the FPGA, but due to the large amount of data of the scanning waveform parameter, the FPGA has insufficient storage space.

Based on this, some embodiments of the present disclosure provide a scanning control apparatus, a method, an apparatus, a medium, a product, and a semiconductor inspection device, which can solve the above problems. Hereinafter, a scanning control apparatus provided by some embodiments of the present disclosure is described in detail.

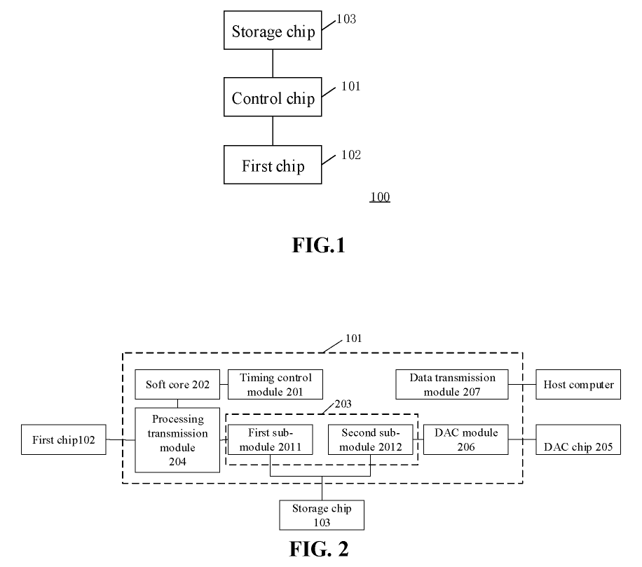

In some embodiments, as shown in FIG. 1, the scanning control apparatus 100 provided in the embodiments of the present disclosure includes a control chip 101, a first chip 102, and a storage chip 103. The control chip 101 can be connected to the first chip 102 and the storage chip 103. The control chip 101 can be a gate array chip, the first chip 102 can be a digital signal processing (DSP) chip, and the storage chip 103 can be a double-data-rate synchronous dynamic random access memory (DDR SDRAM) chip.

In these embodiments, the control chip 101 can be connected to a host computer through a preset interface, the host computer can transmit an image parameter to a register of the control chip 101 through a peripheral component interconnect express (PCLE) based on a first interface, and the control chip 101 can calculate according to an image size in the image parameters to obtain a scanning parameter. The above scanning parameters can include a scanning direction, a scanning point number, and a scanning size. The scanning size can be a size of a generated scanning image, and the scanning point number can be the number of pixels in the scanning image.

The first chip 102 can generate a scanning waveform parameter with a rotation matrix algorithm based on the scanning parameter, and can transmit the scanning waveform parameter to the control chip 101 after the scanning waveform parameter is generated.

The control chip 101 can transmit the scanning waveform parameter to the storage chip 103, and the storage chip 103 can store the scanning waveform parameter.

After the scanning waveform parameter is stored in the storage chip 103, the storage chip 103 can transmit a first signal to the control chip 101.

After receiving the first signal transmitted from the storage chip 103, the control chip 101 can output a control signal, and the control signal can be configured to instruct a generation of a scanning waveform. For example, the control chip 101 can transmit the control signal to a charged particle beam emission device, and the charged particle beam emission device can generate a scanning waveform of a charged particle beam in response to the scanning waveform parameter in the control signal. In this case, the control signal can carry the scanning waveform parameter. The scanning waveform parameter can include a target voltage value, and a coil in a charged particle beam emission module can control the scanning waveform based on the target voltage value.

In some embodiments of the present disclosure, the first chip generates the scanning waveform parameter based on the scanning parameter, the control chip receives the scanning waveform parameter transmitted from the first chip, the scanning waveform parameter is generated by the first chip, so that the generation efficiency of the scanning waveform parameter is improved by adding the first chip with a relatively high computational power and mainly configured to generate the scanning waveform parameter, thereby facilitating the improvement of the semiconductor inspection efficiency. Moreover, the scanning waveform parameter is stored in the storage chip, so that the problem of insufficient storage space of the control chip can be solved, and a storage space of the scanning control apparatus is expanded.

In some embodiments, the outputting, by the control chip, the scanning waveform parameter includes generating, by the control chip, a waveform scanning timing, and outputting, by the control chip, the scanning waveform parameter based on the waveform scanning timing.

In this case, the control chip can generate the waveform scanning timing and output the scanning waveform parameter based on the waveform scanning timing. It can be conceived that the control chip can generate the waveform scanning timing based on the scanning parameter, and the waveform scanning timing can be configured to instruct a timing of data transmission. For example, the waveform scanning timing can be configured to instruct a timing in which the control chip 101 transmits the scanning waveform parameter to the charged particle beam emission module. In this case, the control chip 101 can transmit one data in the scanning waveform parameter to the charged particle beam emission module at a rising edge or a falling edge of a pulse in the waveform scanning timing.

In some embodiments, the control chip 101 can include a timing control module 201 (e.g., State ctrl), and can generate the waveform scanning timing based on the timing control module 201.

In some embodiments, the timing control module 201 can further generate a signal acquisition timing and a signal deviation timing (e.g., a blanker switch timing), the signal acquisition timing can indicate a timing in which a signal acquisition module acquires a charged particle beam reflected by the semiconductor, and the signal deviation timing can indicate a timing in which the signal acquisition module does not acquire the charged particle beam reflected by the semiconductor.

In the embodiments of the present disclosure, the control chip generates the waveform scanning timing, and outputs the scanning waveform parameter based on the waveform scanning timing. The waveform scanning timing is taken as a transmission timing in which the control chip transmits data in the scanning waveform parameter, thereby improving the accuracy of the scanning waveform parameter.

In some embodiments, as shown in FIG. 2, the control chip 101 can include a soft core 202 (e.g., Microsoft balze). Before the first chip 102 generates the scanning waveform parameter based on the scanning parameter, the soft core 202 can acquire the image parameter and generate the scanning parameter based on the image parameter, and the image parameter can include an image size, and then the first chip 102 can the generate scanning waveform parameter based on the scanning parameter.

In the embodiments of the present disclosure, the soft core in the control chip acquires the image parameter, and generates the scanning parameter based on the image parameter, which can achieve "preprocessing" of the image parameter based on the soft core, so that the first chip generates the scanning waveform parameter based on the image parameter, and the generation efficiency of the scanning waveform parameter can be improved.

In some embodiments, as shown in FIG. 2, the control chip 101 can include a direct storage access module 203 (e.g., DDR_Buffer) connected to the storage chip 103. The direct storage access module 203 is configured to transmit the scanning waveform parameter to the storage chip 103 and acquire the scanning waveform parameter from the storage chip 103 in response to receiving the first signal transmitted from the storage chip 103.

In some examples, the direct storage access module 203 can include a second interface, and the direct storage access module 203 can be connected to the storage chip 103 through the second interface. In some examples, the direct storage access module 203 can be replaced with a reading and writing module. With the reading and writing function of the reading and writing module, the scanning waveform parameter is stored in the storage chip 103, and the scanning waveform parameter is acquired from the storage chip 103, which is not repeated herein.

In the embodiments of the present disclosure, the direct storage access module 203 in the control chip 101 is connected to the storage chip 103, and the steps of storing, by the direct storage access module 203, the scanning waveform parameter to the storage chip 103 and acquiring the scanning waveform parameter from the storage chip 103 are executed by the direct storage access module 203, so that the integrity and accuracy of data writing and retrieval can be achieved, thereby achieving data transmission between the control chip 101 and the storage chip 103.

In some embodiments, as shown in FIG. 2, the direct storage access module 203 can include a first sub-module 2011 and a second sub-module 2012 that are connected to the storage chip 103, the first sub-module 2011 is configured to transmit the scanning waveform parameter to the storage chip 103, and the second sub-module 2012 is configured to acquire the scanning waveform parameter from the storage chip 103.

As shown in FIG. 2, the direct storage access module 203 can include the first sub-module 2011 and the second sub-module 2012, the first sub-module 2011 can transmit the scanning waveform parameter to the storage chip 103, and the second sub-module 2012 can acquire the scanning waveform parameter from the storage chip 103 in response to the second sub-module 2012 receiving the first signal transmitted from the storage chip 103.

In the embodiments of the present disclosure, the first sub-module 2011 and the second sub-module 2012 can achieve the data storage and data acquisition between the control chip 101 and the storage chip 103, respectively, thereby improving data transmission efficiency.

In some embodiments, as shown in FIG. 2, the control chip 101 can include a direct processing transmission module 204 (e.g., Srio Top) connected to the first chip. The processing transmission module 204 is configured to obtain the scanning parameter and transmit the scanning parameter to the first chip 102, receive the scanning waveform parameter transmitted from the first chip 102, and transmit the scanning waveform parameter to the direct storage access module 203. It can be conceived that the processing transmission module 204 can include a first interface such as a Srio interface, and can transmit the scanning parameter to the first chip 102 based on the first interface.

In the embodiments of the present disclosure, the direct processing transmission module 204 can receive the scanning waveform parameter transmitted from the first chip, and then transmit the scanning waveform parameter to the direct storage access module 203, so that a high-speed data transmission is achieved between the control chip 101 and the first chip 102 with the direct processing transmission module.

In some embodiments, the scanning waveform parameter includes a digital scanning waveform parameter, and the scanning control apparatus includes a digital-to-analog converter chip 205 connected to the control chip 101 and configured to convert the digital scanning waveform parameter into an analog scanning waveform parameter.

In this case, the digital-to-analog converter (DAC) chip 205 can convert the digital scanning waveform parameter transmitted from the control chip 101 into the analog scanning waveform parameter, and the analog scanning waveform parameter can include multiple target voltage values, and can be configured to instruct the generation of the scanning waveform, and the DAC chip can transmit the analog scanning waveform parameter to the charged particle beam emission module, and the coil in the charged particle beam emission module can control the scanning waveform based on the multiple target voltage values. In some examples, the control chip 101 can include a third interface, and the control chip 101 can be connected to the digital-to-analog converter chip 205 through the third interface.

In the embodiments of the present disclosure, the digital-to-analog converter chip 205 can convert the digital scanning waveform parameter into the analog scanning waveform parameter that can be identified by the charged particle beam emission module, so that the charged particle beam emission module can be operate normally, thereby achieving the normal semiconductor inspection.

In some embodiments, as shown in FIG. 2, the control chip 101 can include a digital-to-analog converter module 206 (e.g., DAC SUB TOP), a first terminal of the digital-to-analog converter module can be connected to the second sub-module 2012, and the digital-to-analog converter module can be connected to the DAC chip. The digital-to-analog converter module can generate a read enable signal, and transmit the digital scanning waveform parameter to the DAC chip based on the read enable signal. With the digital-to-analog converter module, data transmission between the digital-to-analog converter chip and the control chip can be achieved.

In this case, the digital-to-analog converter module 206 can include the third interface, and the digital-to-analog converter module 206 can be connected to the digital-to-analog converter chip 205 through the third interface.

In some embodiments, as shown in FIG. 2, the control chip 101 can include a data transmission module 207 (e.g., PCIE), and the data transmission module 207 can be connected to the host computer, and data interaction between the control chip 101 and the host computer can be achieved through the data transmission module 207.

In some embodiments, the control chip 101 is configured to acquire a digital image of a semiconductor device, calculate an average value of gray values of multiple pixels in a target area of the digital image, and replace the gray values of the multiple pixels in the target area based on the average value, to obtain a processed image. The digital image is generated by the acquisition module by converting the analog image generated by a charged particle beam reflected by the semiconductor device.

The control chip 101 can acquire a digital image of the semiconductor from the acquisition module, the digital image is generated by the acquisition module by converting the analog image generated by the charged particle beam reflected by the semiconductor device, the digital image can include gray values corresponding to multiple pixels, and the control chip 101 can calculate the average value of the gray values of multiple pixels in the target area of the digital image, and replace the gray values of multiple pixels in the target area based on the average value to obtain the processed image. The digital image can include multiple target areas. For example, an average value of the gray values of every four consecutive pixels can be calculated, and then each of the gray values of the four pixels can be replaced with the average value to obtain a processed image.

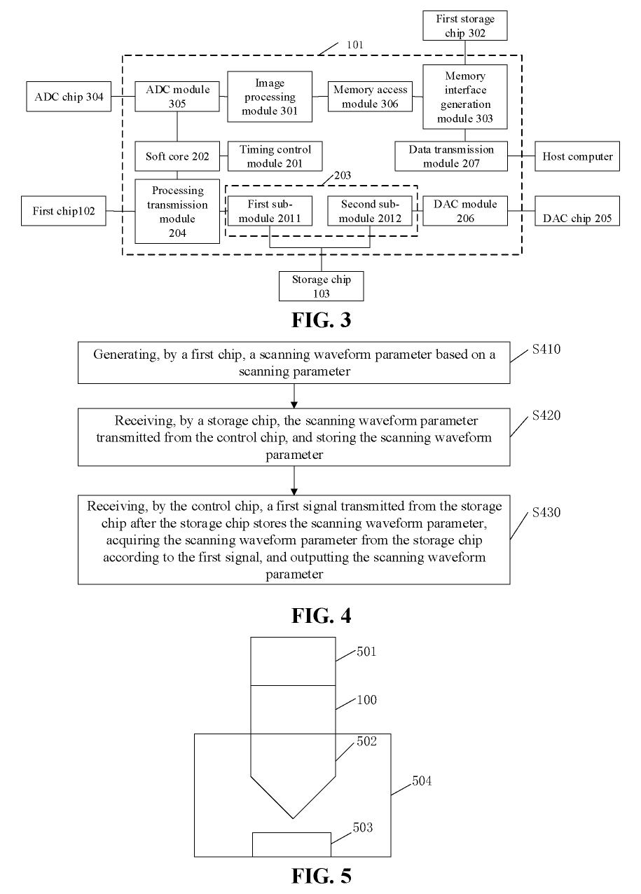

In some embodiments, as shown in FIG. 3, FIG. 3 is another schematic diagram of a scanning control apparatus provided in the embodiments of the present disclosure. As shown in FIG. 3, the control chip 101 can include an image processing module 301 (e.g., Fram average), and the image processing module 301 can be configured to acquire the digital image of the semiconductor device, calculate the average value of the gray values of multiple pixels in the digital image, and replace the gray values of multiple pixels in the target area based on the average value to obtain the processed image. In some examples, taking the digital image including 512 × 512 gray values as an example again, an average value of the gray values of pixels in each column can be calculated to obtain multiple average values, and the gray values of the pixels in a corresponding column can be replaced based on each of the average values to obtain a processed image.

In the embodiments of the present disclosure, the control chip 101 acquires a digital image of a semiconductor, calculates the average value of multiple pixels in the digital image of the semiconductor, calculates an average value of gray values of multiple pixels in a target area of the digital image, and replaces the gray values of the multiple pixels in the target area based on the average value, to obtain a processed image, which can reduce the impact of noise on the gray values of the digital image, and facilitates subsequent inspection of semiconductor defects based on the processed image.

In some embodiments, as shown in FIG. 3, the scanning control apparatus can include a first storage chip 302 that can be connected to an image processing module 301 in the control chip 101, and the first storage chip 302 is configured to receive the processed image transmitted from the control chip 101 and store the processed image.

As shown in FIG. 3, the control chip 101 can store the processed image to the first storage chip 302 for subsequent inspection of semiconductor defects based on the processed image stored in the first storage chip 302.

In some embodiments, as shown in FIG. 2, the control chip 101 can include a memory interface generator (MIG) module 303 that can be disposed between the image processing module 301 and the first storage chip 302, and the MIG module 303 can acquire a processed image from the image processing module 301 and store the processed image to the first storage chip 302. It can conceived that a display device can then acquire the processed image from the first storage chip 302 and display the processed image for users to inspect semiconductor defects based on the processed image.

In some examples, as shown in FIG. 2, the MIG module 303 can be connected to a data transmission module 207 that can transmit an acquisition signal to the MIG module 303 in response to an instruction transmitted by the host computer, the MIG module 303 can acquire the processing image from the first chip and transmit the processing image to the data transmission module 207, and thereafter the data transmission module 207 can transmit the processing image to the host computer.

In the embodiments of the present disclosure, with the first storage chip, the control chip stores the processed image to the first storage chip, which can expand the storage space in which the scanning control apparatus stores the processed image, and the problem of insufficient storage space of the scanning control apparatus can be solved. Classified storage of different data in the scanning control apparatus can be achieved by storing the image in the first storage chip.

In some embodiments, the scanning control apparatus includes an analog-to-digital converter chip 304 analog-to-digital converter connected to the control chip 101, and the analog-to-digital converter chip 304 is configured to acquire an analog image of the semiconductor, and perform analog-to-digital conversion on the analog image to obtain a digital image.

As shown in FIG. 3, the scanning control apparatus can include the analog-to-digital converter chip 304 that can be connected to the control chip 101, the analog-to-digital converter chip 304 can acquire the analog image, convert the analog image into a digital image, and transmit the digital image to the control chip 101. With the analog-to-digital converter chip 304, the analog image of the semiconductor can be converted to obtain the digital image, so that the control chip 101 can calculate an average value of multiple pixels in the digital image, and an image clarity is improved. In this case, the analog image is an image generated by the acquisition module in the semiconductor device by acquiring the charged particle beam reflected by the semiconductor.

In the embodiments of the present disclosure, the analog-to-digital converter chip is provided to acquire the analog image of the semiconductor and convert the analog image into the digital image, so that the control chip processes the digital image thereafter, which facilitates semiconductor defect inspections for users based on the processed image.

In some embodiments, as shown in FIG. 3, the control chip 101 can include an analog-to-digital converter module 305 (e.g., AD SUB TOP), a first terminal of the analog-to-digital converter module 305 can be connected to the analog-to-digital converter chip, a second terminal of the analog-to-digital converter module 305 can be connected to the image processing module 301, and the analog-to-digital converter module 305 can transmit the digital image to the image processing module 301, so that the image processing module can process the digital image. The analog-to-digital converter module 305 can achieve data interaction between the control chip 101 and the analog-to-digital converter chip 304, so that the image processing module in the control chip can process the digital image, which facilitates semiconductor defect inspection for users based on the processed image.

In this case, the analog-to-digital converter module 305 can include a fourth interface, and can be connected to the analog-to-digital converter chip 304 through the fourth interface.

In some embodiments, as shown in FIG. 3, the control chip 101 can include a direct memory access (DMA) module 306, a first terminal of the DMA module 306 is connected to the image processing module 301, and a second terminal of the DMA module 306 can be connected to the MIG module 303.

The DMA module 306 can acquire the processed image from the image processing module 301 and transmit the processed image to the MIG module 303, so that MIG module 303 can store the processed image to the first storage chip 302.

In the embodiments of the present disclosure, with the DMA module, the processed image can be transmitted from the image processing module to the MIG module, which can achieve efficient and large-scale movement of data without a central processing unit (CPU).

In some embodiments, as shown in FIG. 4, a scanning control method provided by some embodiments of the present disclosure is applied to a scanning control apparatus, the scanning control apparatus includes a control chip, a first chip, and a storage chip, and the control chip is connected to the first chip and the storage chip. The method can include the following steps S410-S430.

In S410, the first chip generates a scanning waveform parameter based on a scanning parameter.

In S420, the scanning waveform parameter transmitted from the control chip is received by the storage chip, and the scanning waveform parameter is stored, the scanning waveform parameter being a parameter transmitted from the first chip to the control chip.

In S430, the control chip receives a first signal transmitted from the storage chip after the storage chip stores the scanning waveform parameter, the scanning waveform parameter is acquired from the storage chip according to the first signal, and the scanning waveform parameter is output, the scanning waveform parameter being configured to instruct a generation of a scanning waveform.

In the embodiments of the present disclosure, the waveform scanning parameter is generated by the first chip based on the scanning parameter, the waveform scanning parameter transmitted from the first chip is received by the control chip, the scanning waveform parameter is stored in the storage chip, and in the case that the control chip receives the first signal transmitted from the storage chip, the scanning waveform parameter is acquired from the storage chip, and the scanning waveform parameter is output. In this way, the generation efficiency of the scanning waveform parameter can be improved, thereby facilitating improving the semiconductor inspection efficiency. Moreover, the scanning waveform parameter is stored in the storage chip, so that the problem of insufficient storage space of the control chip can be solved, and a storage space of the scanning control apparatus is expanded.

In some embodiments, outputting the scanning waveform parameter by the control chip includes: generating, by the control chip, a waveform scanning timing, and outputting, by the control chip, the scanning waveform parameter based on the waveform scanning timing, the waveform scanning timing being configured to control a transmission frequency.

In some embodiments, the scanning waveform parameter is generated by the first chip based on the scanning parameter, and the method includes acquiring the image parameter by a soft core in the control chip, and generating the scanning parameter based on the image parameter.

In some embodiments, transmitting the scanning waveform parameter to the storage chip by the control chip includes transmitting the scanning waveform parameter to the storage chip by the direct storage access module in the control chip; and acquiring, by the control chip, the scanning waveform parameter from the storage chip in response to the first signal includes acquiring, by the direct storage access module, the scanning waveform parameter from the storage chip in response to the first signal.

In some embodiments, transmitting the scanning waveform parameter to the storage chip by the direct storage access module in the control chip includes transmitting the scanning waveform parameter to the storage chip by a first sub-module in the direct storage access module; and acquiring, by the direct storage access module in the control chip, the scanning waveform parameter from the storage chip in response to the first signal includes acquiring, by a second sub-module, the scanning waveform parameter from the storage chip in the direct memory access module in response to the first signal.

In some embodiments, receiving, by the control chip, the scanning waveform parameter transmitted from the first chip and transmitting the scanning waveform parameter to the storage chip include acquiring the scanning parameter by a direct memory access module in the control chip, and transmitting the scanning parameter to the first chip; and receiving the scanning waveform parameter transmitted from the first chip, and transmitting the scanning waveform parameter to the direct storage access module.

In some embodiments, the scanning waveform parameter includes a digital scanning waveform parameter, and after the control chip transmits a control signal for generating the scanning waveform based on the scanning waveform parameter, the method can include converting, by a digital-to-analog converter chip, the digital scanning waveform parameter into the analog scanning waveform parameter.

In some embodiments, after the control chip transmits the control signal for generating the scanning waveform based on the scanning waveform parameter, the method can include acquiring a digital image of the semiconductor by the control chip, calculating the average value of the gray values of multiple pixels in the digital image, and replacing the gray values of multiple pixels in the target area based on the average value to obtain a processed image.

In some embodiments, before the digital image of the semiconductor is acquired by the control chip, the method includes: acquiring an analog image of the semiconductor by an analog-to-digital converter chip, and performing analog-to-digital conversion on the analog image to obtain the digital image.

The method in the above embodiments is applied to the corresponding scanning control apparatus in any one of the above embodiments and has the beneficial effects of the embodiments of the corresponding apparatus, which is not repeated herein.

The method in the above embodiments is a method for controlling components in the above apparatus based on the above apparatus and has the same beneficial effects as the above embodiments of the apparatus, which is not repeated herein.

Based on the same inventive concept, some embodiments of the present disclosure provide a semiconductor inspection device.

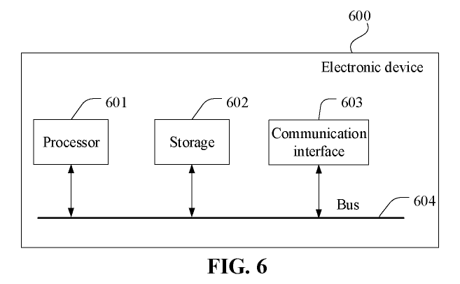

In some embodiments, as shown in FIG. 5, some embodiments of the present disclosure provide a semiconductor inspection device, and the semiconductor inspection device can include a charged particle beam emission module 501 and the above scanning control apparatus 100. The scanning control apparatus 100 is configured to transmit a control signal of the scanning waveform to the charged particle beam emission module, the control signal carrying the scanning waveform parameter. The charged particle beam emission module 501 is configured to generate a scanning waveform of a charged particle beam in response to the scanning waveform parameter.

In the embodiments of the present disclosure, the semiconductor inspection device includes the above charged particle beam emission module and the scanning control apparatus, which can improve the generation efficiency of the scanning waveform parameter.

In some examples, the above semiconductor inspection device can be an SEM device.

In this case, as shown in FIG. 4, the semiconductor inspection device can generate the scanning waveform parameter by the above scanning control apparatus 100; the charged particle beam emission module 501 emits the charged particle beam to the semiconductor 503 is in response to a control signal transmitted from the scanning control apparatus; the acquisition module 502 acquires the charged particle beam reflected by the semiconductor 503 in a cavity 504 to generate an analog image; then the analog image is processed and stored based on the above scanning control apparatus to obtain a processed image, which facilitates the subsequent semiconductor defect inspection for users based on the processed image.

FIG. 6 is a schematic diagram of a hardware of an electronic device provided in some embodiments of the present disclosure.

The electronic device can include a processor 601 and a storage 602 storing computer program instructions.

Specifically, the processor 601 can include a central processing unit (CPU), or an application specific integrated circuit (ASIC), or can be configured as one or more integrated circuits for implementing the embodiments of the present disclosure.

The storage 602 can include mass storage for data or instructions. By way of example but not limitation, the storage 602 can include a hard disk drive (HDD), a floppy disk drive, a flash memory, an optical disk, a magneto-optical disk, a magnetic tape, or a universal serial bus (USB) drive, or a combination of two or more thereof. When appropriate, the storage 602 can include a removable or non-removable (or fixed) medium. Where appropriate, the storage 602 can be internal or external to an integrated gateway disaster recovery device. In a particular embodiment, the storage 602 is a non-transitory solid state storage.

In particular embodiments, the storage 602 includes a read only memory (ROM). Where appropriate, the ROM can be a mask-programmed ROM, a programmable ROM (PROM), an erasable PROM (EPROM), an electrically erasable PROM (EEPROM), an electrically alterable ROM (EAROM), flash memory, or a combination of two or more thereof.

The storage can include a read only memory (ROM), a random access memory (RAM), a magnetic disk storage media device, an optical storage media device, a flash memory device, an electrical, optical or other physical/tangible memory storage device. Thus, in general, the storage includes one or more tangible (non-transitory) computer-readable storage media (e.g. a storage device) having data embodied in software including computer-executable instructions, and the software, when executed (e.g. by one or more processors), is operable to perform the operations described in the methods according to embodiments of the present disclosure.

The processor 601 implements the scanning control method in any one of the above embodiments by reading and executing the computer program instructions stored in the storage 602.

In an example, the electronic device can include a communication interface 603 and a bus 604. As shown in FIG. 6, the processor 601, the storage 602, and the communication interface 603 are connected to each other and communicate with each other through the bus 604.

The communication interface 603 is mainly configured to implement communication between various modules, apparatus, units and/or devices in the embodiments of the present disclosure.

The bus 604 includes a hardware, a software, or both, and couples the components of an online data traffic charging device to each other. By way of example and not limitation, the bus can include an accelerated graphics port (AGP) or other graphics buses, an enhanced industry standard architecture (EISA) bus, a front side bus (FSB), a hyper transport (HT) interconnect, an industry standard architecture (ISA) bus, an infinite bandwidth interconnect, a low pin count (LPC) bus, a storage bus, a micro channel architecture (MCA) bus, a peripheral component interconnect (PCI) bus, a PCI-Express (PCI-X) bus, a serial advanced technology attachment (SATA) bus, a video electronics standards association local bus (VLB) bus, or other suitable buses, or a combination thereof. When appropriate, the bus 604 can include one or more buses. Although the embodiments of the present disclosure describe and illustrate particular buses, any suitable bus or interconnect is taken into account in the present disclosure.

The electronic device according to the embodiments is configured to implement a corresponding scanning control method in any one of the foregoing embodiments, and has the beneficial effects of corresponding embodiments of the method, which is not repeated herein.

In addition, the embodiments of the present disclosure can provide a computer storage medium for implementing a scanning control method in any one of the foregoing embodiments. The computer storage medium stores computer program instructions which, when executed by a processor, implement any one of the methods for generating a waveform in the above embodiments.

In addition, the embodiments of the present disclosure can provide a computer program product to implement the scanning control method in the above embodiments. The instructions in the computer program product, when executed by the processor of the electronic device, implement the scanning control method in any one of the above embodiments.

A person skilled in the art should appreciate that the discussion of any of the above embodiments is only exemplary, but not to imply that the scope of the present disclosure (including the claims) is limited to these examples. Under the concept of the present disclosure, technological features of the above embodiments or different embodiments can be combined, the steps can be implemented in any order, and there are many other variations of different aspects of the embodiments of the present disclosure described above, which are not described in detail for clarity.

The functional modules shown in the structural block diagrams can be implemented as hardware, software, firmware, or a combination thereof. When implemented as hardware, it can be, for example, an electronic circuit, an application specific integrated circuit (ASIC), a suitable firmware, a plug-in, a functional card, and the like. When implemented in software, the elements of the present disclosure are programs or code segments used to carry out the required tasks. The programs or code segments can be stored in a machine-readable medium or transmitted by a data signal carried in a carrier wave over a transmission medium or communication link. The “machine-readable medium” can include any medium capable of storing or transmitting information. An example of the machine-readable medium includes an electronic circuit, a semiconductor memory device, a ROM, a flash memory, an erasable ROM (EROM), a floppy disk, a CD-ROM, an optical disk, a hard disk, a fiber optic medium, a radio frequency (RF) link, and the like. The code segments can be downloaded via a computer network such as the Internet, intranet, and the like.

It should also be noted that, in the exemplary embodiments mentioned in the present disclosure, some methods or systems are described based on a series of steps or apparatuses. However, the present disclosure is not limited to the order of the above steps, that is, the steps can be performed in the order mentioned in the embodiments, or can be performed in the order different from that in the embodiments, or several steps can be performed at the same time.

Aspects of the present disclosure are described above with reference to flowcharts and/or block diagrams of methods, apparatuses and computer program products according to the embodiments of the present disclosure. It should be understood that each block in the flowcharts and/or block diagrams, and combinations of blocks in the flowcharts and/or block diagrams, can be implemented by the computer program instructions. These computer program instructions can be provided to a processor of a general purpose computer, a special purpose computer or other programmable data processing apparatus to produce a machine, so that these instructions which are executed by the processor of the computer or other programmable data processing apparatus enable the implementation of the functions/actions specified in one or more blocks of the flowcharts and/or block diagrams. Such a processor can be, but is not limited to, a general purpose processor, a special purpose processor, an application specific processor, or a field programmable logic circuit. It can also be understood that each block in the block diagrams and/or flowcharts and the combinations of blocks in the block diagrams and/or flowcharts can also be implemented by special purpose hardware that performs the specified functions or actions or can be implemented by the combinations of the special purpose hardware and the computer instructions.

The above are only specific implementations of the present disclosure, those skilled in the art can clearly understand that the specific operating processes of the above systems, modules and units can be referred to the corresponding processes in the embodiments of the foregoing method, which is not repeated here for the convenience and brevity of the description. It should be understood that the protection scope of the present disclosure is not limited to this, and any person skilled in the art can easily think of various equivalent modifications or replacements within the technical scope disclosed in the present disclosure, and these modifications or replacements should all fall within the protection scope of the present disclosure.

What is claimed is:

1. A scanning control apparatus, comprising:
a control chip;
a first chip configured to generate a scanning waveform parameter based on a scanning parameter; and
a storage chip configured to receive the scanning waveform parameter transmitted from the first chip through the control chip, and configured to store the scanning waveform parameter,
wherein the control chip is connected to the first chip and the storage chip and is configured to receive a first signal transmitted from the storage chip after the storage chip stores the scanning waveform parameter, acquire the scanning waveform parameter from the storage chip according to the first signal, and output the scanning waveform parameter, the scanning waveform parameter being configured to instruct a generation of a scanning waveform.

2. The scanning control apparatus as described in claim 1, wherein the outputting, by the control chip, the scanning waveform parameter comprises:
generating, by the control chip, a waveform scanning timing; and
outputting, by the control chip, the scanning waveform parameter based on the waveform scanning timing.

3. The scanning control apparatus as described in claim 1, wherein the control chip comprises:
a soft core, the soft core being configured to acquire an image parameter before the first chip is configured to generate, based on the scanning parameter, the scanning waveform parameter, and being configured to generate the scanning parameter based on the image parameter.

4. The scanning control apparatus as described in claim 1, wherein the control chip comprises:
a direct storage access module connected to the storage chip, and configured to transmit the scanning waveform parameter to the storage chip and acquire the scanning waveform parameter from the storage chip.

5. The scanning control apparatus as described in claim 4, wherein the direct storage access module comprises:
a first sub-module connected to the storage chip and configured to transmit the scanning waveform parameter to the storage chip;
a second sub-module connected to the storage chip and configured to acquire the scanning waveform parameter from the storage chip.

6. The scanning control apparatus as described in claim 4, wherein the control chip further comprises:
a direct memory access module configured to acquire the scanning parameter, transmit the scanning parameter to the first chip, receive the scanning waveform parameter transmitted from the first chip, and transmit the scanning waveform parameter to the direct storage access module.

7. The scanning control apparatus as described in claim 1, further comprising:
a digital-to-analog converter chip connected to the control chip, the scanning waveform parameter comprising a digital scanning waveform parameter, and the digital-to-analog converter chip being configured to convert the digital scanning waveform parameter into an analog scanning waveform parameter.

8. The scanning control apparatus as described in claim 1, wherein the control chip is further configured to acquire a digital image of a semiconductor, calculate an average value of gray values of a plurality of pixels in a target region in the digital image, and replace the gray values of the plurality of pixels in the target region based on the average value to obtain a processed image.

9. The scanning control apparatus as described in claim 8, further comprising:
an analog-to-digital converter chip connected to the control chip and configured to acquire an analog image of a semiconductor and perform analog-to-digital conversion on the analog image to obtain the digital image.

10. A semiconductor inspection device, comprising:
a charged particle beam emission module; and
a scanning control apparatus,
wherein
the scanning control apparatus comprises a control chip, a first chip configured to generate a scanning waveform parameter based on a scanning parameter, and a storage chip configured to receive the scanning waveform parameter transmitted from the first chip through the control chip, and store the scanning waveform parameter, the control chip being connected to the first chip and the storage chip and being configured to receive a first signal transmitted from the storage chip after the storage chip stores the scanning waveform parameter, acquire the scanning waveform parameter from the storage chip according to the first signal, and output the scanning waveform parameter, the scanning waveform parameter being configured to instruct a generation of a scanning waveform; and
the scanning control apparatus is configured to transmit the scanning waveform parameter to the charged particle beam emission module, and the charged particle beam emission module is configured to generate a scanning waveform of a charged particle beam in response to the scanning waveform parameter.

11. The semiconductor inspection device as described in claim 10, wherein the outputting, by the control chip, the scanning waveform parameter comprises:
generating, by the control chip, a waveform scanning timing; and
outputting, by the control chip, the scanning waveform parameter based on the waveform scanning timing.

12. The semiconductor inspection device as described in claim 10, wherein the control chip comprises:
a soft core, the soft core being configured to acquire an image parameter before the first chip is configured to generate, based on the scanning parameter, the scanning waveform parameter, and being configured to generate the scanning parameter based on the image parameter.

13. The semiconductor inspection device as described in claim 10, wherein the control chip comprises:
a direct storage access module connected to the storage chip, and configured to transmit the scanning waveform parameter to the storage chip and acquire the scanning waveform parameter from the storage chip.

14. The semiconductor inspection device as described in claim 13, wherein the direct storage access module comprises:
a first sub-module connected to the storage chip and configured to transmit the scanning waveform parameter to the storage chip;
a second sub-module connected to the storage chip and configured to acquire the scanning waveform parameter from the storage chip.

15. The semiconductor inspection device as described in claim 13, wherein the control chip further comprises:
a direct memory access module configured to acquire the scanning parameter, transmit the scanning parameter to the first chip, receive the scanning waveform parameter transmitted from the first chip, and transmit the scanning waveform parameter to the direct storage access module.

16. The semiconductor inspection device as described in claim 10, wherein the scanning control apparatus further comprises:
a digital-to-analog converter chip connected to the control chip, the scanning waveform parameter comprising a digital scanning waveform parameter, and the digital-to-analog converter chip being configured to convert the digital scanning waveform parameter into an analog scanning waveform parameter.

17. The semiconductor inspection device as described in claim 1, wherein the control chip is further configured to acquire a digital image of a semiconductor, calculate an average value of gray values of a plurality of pixels in a target region in the digital image, and replace the gray values of the plurality of pixels in the target region based on the average value to obtain a processed image.

18. The semiconductor inspection device as described in claim 17, wherein the scanning control apparatus further comprises:
an analog-to-digital converter chip connected to the control chip and configured to acquire an analog image of a semiconductor and perform analog-to-digital conversion on the analog image to obtain the digital image.

19. A scanning control method, applied to a scanning control apparatus, wherein
the scanning control apparatus comprises a control chip, a first chip, and a storage chip, the control chip being connected to the first chip and the storage chip; and
the scanning control method comprises:
generating, by the first chip, a scanning waveform parameter based on a scanning parameter;
receiving, by the storage chip, the scanning waveform parameter transmitted from the control chip, and storing the scanning waveform parameter that is a parameter transmitted from the first chip to the control chip; and
receiving, by the control chip, the first signal transmitted from the storage chip after the storage chip stores the scanning waveform parameter, acquiring the scanning waveform parameter from the storage chip according to the first signal, and outputting the scanning waveform parameter, the scanning waveform parameter being configured to instruct a generation of a scanning waveform.

20. A non-transitory computer readable storage medium, storing computer program instructions which, when executed by the processor, cause a processor to perform the scanning control method as described in claim 11.
